(19) United States
(12) Patent Application Publication
(10) Pub. No.: US 2019/0087534 A1
(43) Pub. Date: Mar. 21, 2019

(54) SYSTEMS, METHODS, AND PROCESSOR-READABLE MEDIA FOR DETECTING DISEASE CAUSAL VARIANTS

(71) Applicant: The Penn State Research Foundation, University Park, PA (US)

(72) Inventor: Yu Zhang, Scarsdale, NY (US)

(21) Appl. No.: 16/136,533

(22) Filed: Sep. 20, 2018

Related U.S. Application Data
(60) Provisional application No. 62/561,574, filed on Sep. 21, 2017.
(60) Provisional application No. 62/573,318, filed on Oct. 17, 2017.

(51) Int. Cl. G06F 19/16; G06F 19/18; G06F 17/16

(52) U.S. Cl. CPC G06F 19/16; G06F 17/16; G06F 19/18

(57) ABSTRACT

Systems, methods and readable media for detecting disease causal variants are disclosed. A method includes predicting regulatory functions across a genome in a plurality of cell types, wherein the plurality of cell types include incomplete data, obtaining data including disease loci from one or more genome-wide association studies (GWAS) hits, predicting one or more disease impactful functions on the plurality of cell types based on the data including disease loci, and predicting one or more target genes of disease mutation in the plurality of cell types from the one or more disease impactful functions.

### CROSS-REFERENCE TO RELATED APPLICATIONS

The present application claims priority to U.S. Provisional Patent Application Ser. No. 62/561,574, entitled “SYSTEMS AND METHODS FOR DETECTING DISEASE CASUAL VARIANTS” and filed on Sep. 21, 2017, and claims priority to U.S. Provisional Patent Application Ser. No. 62/573,318, entitled “SYSTEMS AND METHODS FOR DETECTING DISEASE CASUAL VARIANTS” and filed on Oct. 17, 2017, the contents of both are incorporated by reference herein in their respective entireties.

### STATEMENT OF GOVERNMENT SUPPORT

This invention was made with government support under Grant Nos. HG004718 and DK106766 awarded by the National Institutes of Health. The Government has certain rights in the invention.

### BACKGROUND

Field

The present specification generally relates to systems and methods for predicting diseases and, more particularly, to systems and methods that utilize statistical methods for detecting disease causal variants by integrating functional data in all human cell types.

### Technical Background

Genome-wide association studies (GWAS) have achieved tremendous milestones for detecting genetic variants associated with hundreds of human complex traits. About 90% of the detected GWAS variants to date are located in non-coding regions and at least a portion of them are estimated to be non-causal. This is in part due to the strong linkage disequilibrium (LD) among genetic variants, ascertainment bias, genetic heterogeneity and environmental confounding factors. It thus greatly hinders the capability to pinpoint disease causal mutations. New methods are needed to leverage information beyond genetic data to identify and interpret non-coding causal variants and their molecular targets in the post GWAS era.

### SUMMARY

In an embodiment, a method for detecting disease causal variants includes predicting regulatory functions across a genome in a plurality of cell types, wherein the plurality of cell types include incomplete data, obtaining data including disease loci from one or more genome wide association studies (GWAS) hits, predicting one or more disease impactful functions on the plurality of cell types based on the data including disease loci, and predicting one or more target genes of disease mutation in the plurality of cell types from the one or more disease impactful functions.

In another embodiment, a system for detecting disease causal variants includes a processing device and a non-transitory, processor-readable storage medium having one or more programming instructions stored thereon. The one or more programming instructions, when executed, cause the processing device to predict regulatory functions across a genome in a plurality of cell types, wherein the plurality of cell types include incomplete data, obtain data including disease loci from one or more genome wide association studies (GWAS) hits, predict one or more disease impactful functions on the plurality of cell types based on the data including disease loci, and predict one or more target genes of disease mutation in the plurality of cell types from the one or more disease impactful functions.

In yet another embodiment, a non-transitory, processor-readable storage medium includes one or more programming instructions stored thereon. The programming instructions are executable to predict regulatory functions across a genome in a plurality of cell types, wherein the plurality of cell types include incomplete data, obtain data including disease loci from one or more genome wide association studies (GWAS) hits, predict one or more disease impactful functions on the plurality of cell types based on the data including disease loci, and predict one or more target genes of disease mutation in the plurality of cell types from the one or more disease impactful functions.

In yet another embodiment, a system for detecting disease causal variants includes a user computing device and a server computing device communicatively coupled to the user computing device. The user computing device receives raw experimental data of epigenetic marks in a plurality of cell types from a user and provides human interpretable and visualizable forms of the raw experimental data to the user, where the raw experimental data includes one or more genome-wide association studies (GWAS) hits containing disease loci. The server computing device is programmed to receive the raw experimental data from the user computing device, predict regulatory functions across a genome in a plurality of cell types, where the plurality of cell types include incomplete data, predict one or more disease impactful functions on the plurality of cell types based on the data comprising disease loci, and predict one or more target genes of disease mutation in the plurality of cell types from the one or more disease impactful functions.

In yet another embodiment, a system for detecting disease causal variants includes a user computing device and a server computing device communicatively coupled to the user computing device. The user computing device provides human interpretable and visualizable forms of raw experimental data to the user, where the raw experimental data includes one or more genome-wide association studies (GWAS) hits containing disease loci. The server computing device is programmed to receive partial epigenetic data of new cell types contained within the raw experimental data from a data repository, predict regulatory functions across a genome in a plurality of cell types, where the plurality of cell types include incomplete data, predict one or more disease impactful functions on the plurality of cell types based on the data including disease loci, and predict one or more target genes of disease mutation in the plurality of cell types from the one or more disease impactful functions.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 depicts an illustrative computing network containing systems for implementing methods of detecting disease causal variants according to one or more embodiments shown and described herein;

FIG. 2 depicts illustrative hardware components of a system for detecting disease causal variants according to one or more embodiments shown and described herein.

FIG. 3 is a chart depicting a distribution of a number of independent hits in a GWAS catalog;

FIG. 4 depicts a flow diagram of an illustrative method of detecting disease causal variants by integrating functional data in all human cell types according to one or more embodiments shown and described herein;

FIG. 5 schematically depicts predicting functional elements in HL60 time course using ATAC-seq plus ENCODE annotation in the same region according to one or more embodiments shown and described herein;

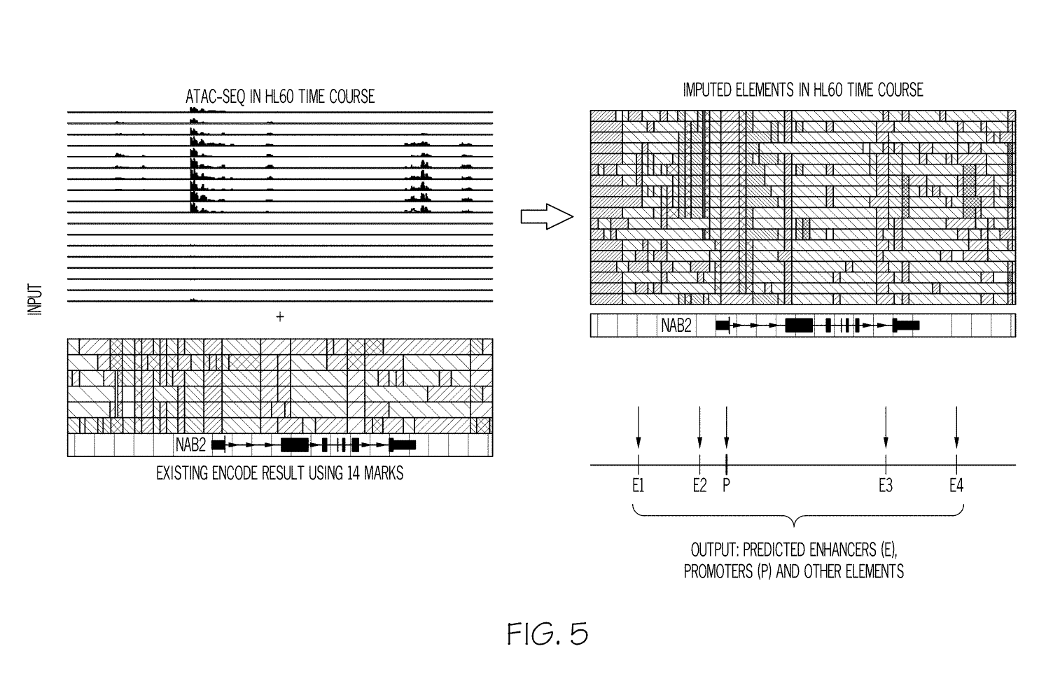

FIG. 6 schematically depicts a probability of inflammatory bowel disease (IBD) causal mutation predicted at the SKAP2 locus using genetic data alone and by combining function annotations overlapped in the background according to one or more embodiments shown and described herein;

FIG. 7A is a graphical depiction of IBD variants that are most likely to impact each of a plurality of cell types according to one or more embodiments shown and described herein; and

FIG. 7B is another graphical depiction of IBD variants that are most likely to impact each of a plurality of cell types according to one or more embodiments shown and described herein.

### DETAILED DESCRIPTION

Recent studies have shown that disease mutations are highly enriched in gene regulatory regions, and they are likely to affect disease risk at the regulatory level in a cell-type specific manner. Using massively parallel sequencing technologies, thousands of genome-wide data sets have been generated on epigenetic marks and gene expression that quantify the regulatory activity of hundreds of human cell types and primary ex vivo tissues. Using these data sets, disease causal mutations can be better identified and their molecular effects in a cell-type dependent context can be understood.

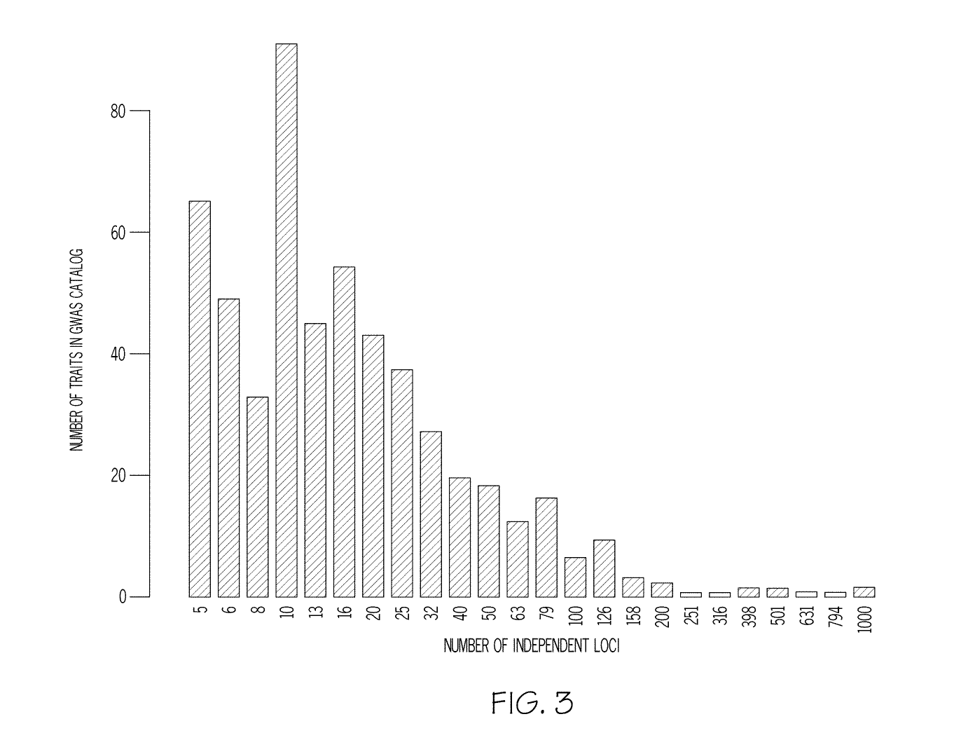

Although numerous computational methods have been developed to use epigenetic data to predict functions and prioritize disease variants in GWAS, they have limited applicability in many complex traits and diseases due to several reasons. First, the user is often required to select disease relevant cell types before analysis, the information of which is unknown to most diseases. Second, the model used for predicting disease mutations is often complex with many parameters, for which a large number of GWAS hits are required to train the model. This is unrealistic because most diseases only have a handful number of significant hits identified to date, as shown, for example, in FIG. 3, which depicts the distribution of the number of independent hits in a GWAS catalog. Third, existing methods mainly focus on predicting disease variants without offering new insights on the underlying regulatory functions, cell types and genes that drive the disease association. Such information is often acquired in low-throughput manner by mining literatures and. Accordingly, there is an unmet need for high-throughput, interpretable and broadly applicable methods for predicting functions, cell types and genes that lead DNA mutations to disease.

The present disclosure introduces new statistical methods for detecting disease causal variants by integrating functional data in all human cell types. Unique to existing methods, the approach disclosed herein has the potential to identify effector cell types and genes through which the causal mutations are driving disease association. Simultaneously, the approach described herein only requires small input from existing GWAS results, and thus is broadly applicable to most complex traits. As a result, the methods employed herein do not require an excessive amount of data to be used, and thus reduce the amount of data storage that is necessary by computing devices performing the methods described herein, thereby improving computer functionality.

The technology described herein converts raw experimental data of epigenetic marks in multiple cell types to human interpretable and visualizable forms called “epigenetic states”. The epigenetic states are useful representations of biological functions, information of which can be broadly leveraged in gene regulation studies and biomedical studies. The technology described herein further uses the “epigenetic states” to predict disease causal mutations, estimates mutation effects on functions, and identifies cell types in which the mutations are most likely to have impact on disease risk. This latter task of identifying cell types is particularly important, because a mutation affects phenotype only through specific biological pathways that involve particular genes expressed in specific human cell types. Information regarding the pathways leading from mutation to disease is largely unknown. The predictions described herein thus will help narrowing down the huge list of candidates and facilitate discovering therapeutic targets.

Existing tools largely rely on one-dimensional models that ignore either cell type identity or genomic location specificity. They are designed to analyze just one cell type at a time. As a result, existing tools are not as accurate as an Integrative and Discriminative Epigenome Annotation System (IDEAS) method in terms of predicting epigenetic states in multiple cell types. Existing results are also sensitive to noise and bias in the data such that their results are not ideal for comparison across cell types. The IDEAS method is a two-dimensional method that accounts for both cell type identity and genomic location specificity and predict epigenetic states in multiple cell types jointly. Not only the IDEAS method produces more accurate and coherent results across cell types, but also it runs in linear time with respect to the number of cell types analyzed. This latter feature is significant because there are hundreds of different tissues and cell types in human and mouse genome, for which IDEAS is currently the only computationally feasible solution to analyze this scale of the data, while simultaneously models both cell type identity and location specificity. As such, improved computing device performance is realized from this feature, as the computing device is able to more efficiently carry out the methods described herein without additional processing power to do so.

Originally, only 6 cell types were studied. However, the present disclosure has improved the computational efficiency of the IDEAS method and implemented parallel computing capability, so that the IDEAS software can now analyze greater than 100 human cell types using genome-wide data in a single computer with 16 cores and 32 Gb memory within one day. In addition, a pipeline has been developed to make robust predictions by the IDEAS method. This is a critically important advance over existing methods, as independent runs of existing methods, including previous IDEAS software, often result in different predictions. This is because globally best predictions cannot be guaranteed in theory. In biology however, robust predictions are required, otherwise the results cannot be reliably used. Thus, the present method to improve stability is a significant contribution.

A fundamental limitation of the current IDEAS method is that it requires a complete list of epigenetic data in all cell types as input. This is unrealistic because most studies have incomplete data due to budget limits. One existing solution is to computationally impute the missing data, which however introduces bias and costs a huge amount of computing and data storage resources. The present development of the IDEAS method is to directly accommodate incomplete data to make predictions. This will greatly expand the applicability of the IDEAS software to most existing and future studies. It will also allow users to leverage existing results in public domains to make predictions in their own data with minimum requirement of data production.

In addition, there are many existing methods that try to use epigenetic data (raw signal or states) to predict disease mutations, and they do work well. However, they require a large number of inputs from known genetic risk factors, which limits their applicability to most human complex diseases. Also, existing methods do not provide ways to computationally estimate functional impact of mutations and the underlying cell types that drive disease risks. The methods described herein use IDEAS predictions as predictor, and known disease mutations as response, to identify the functional effects of mutations and the effector cell types. The computational predictions described herein are made, which are high-throughput, but ultimately the predictions have to be experimentally validated. However, experimental validation is costly and challenging, which is why the present computational predictions may be useful in order to narrow done the set of candidates. A technical advance in the presently disclosed methods is that it can be broadly applied to most human diseases. In most human complex diseases, only a small number of genetic risk factors are known, for which existing predictive models generally do not work well. This is because existing methods require training of models with thousands parameters to capture tissue-specific genetic effects on disease risk, for which hundreds of thousands or millions of whole-genome summary statistics are needed. Only about five percent (5%) of the existing disease studies have made whole-genome summary statistics available to date, while the remaining studies only released significant genetic risk factors to the public, which are not sufficient to train large models.

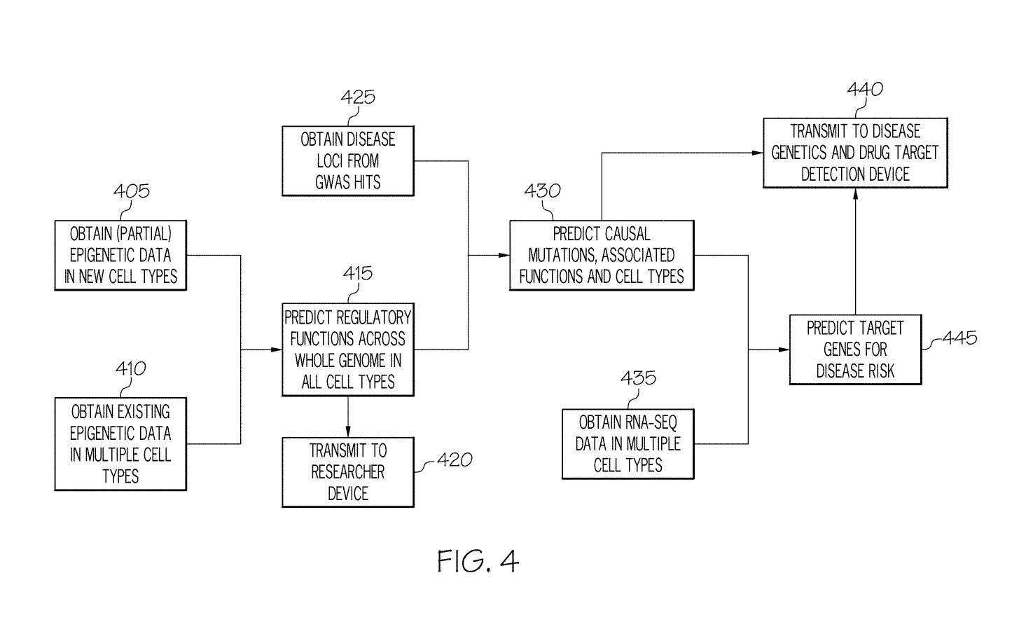

There are three parts in the IDEAS methodology: (1) a powerful imputation method has been developed based on the IDEAS method (Zhang et al., “Jointly characterizing epigenetic dynamics across multiple human cell types,” Nucleic Acids Research, 2016 (incorporated herein by reference)) to predict functions in new cell types of disease relevance. The significance is that the method of the present disclosure allows computational prediction of functions by leveraging results from public data set without requiring complete data in the new cell types. The method described herein thus may substantially save data generation cost and is broadly applicable to most disease relevant data. (2) A model to estimate function-specific and cell type-specific effects of DNA mutations on disease risks has been developed. Distinct from existing solutions, a majority of which is based on enrichment analysis, a joint model is used to account for correlation between regulatory functions among cell types and use their genome-wide patterns at GWAS loci to identify functions and target cell types driving disease association. The significance is that not only are causal mutations and their driver cell types for the disease predicted, but also the method is broadly applicable to many diseases with a handful amount of significant hits. (3) RNA-seq data across cell types are incorporated to predict target genes of causal variants in specific cell types through which the variants impact disease risks. This is currently the most challenging step for studying molecular effects of DNA mutations, as regulatory regions can be hundreds or a million base pairs away from their target genes. The significance of this step is thus to computationally enhance capability to pinpoint target genes of disease mutations in specific cell types. A flow chart describing the pipeline of this work is shown in FIG. 4, as described in greater detail herein.

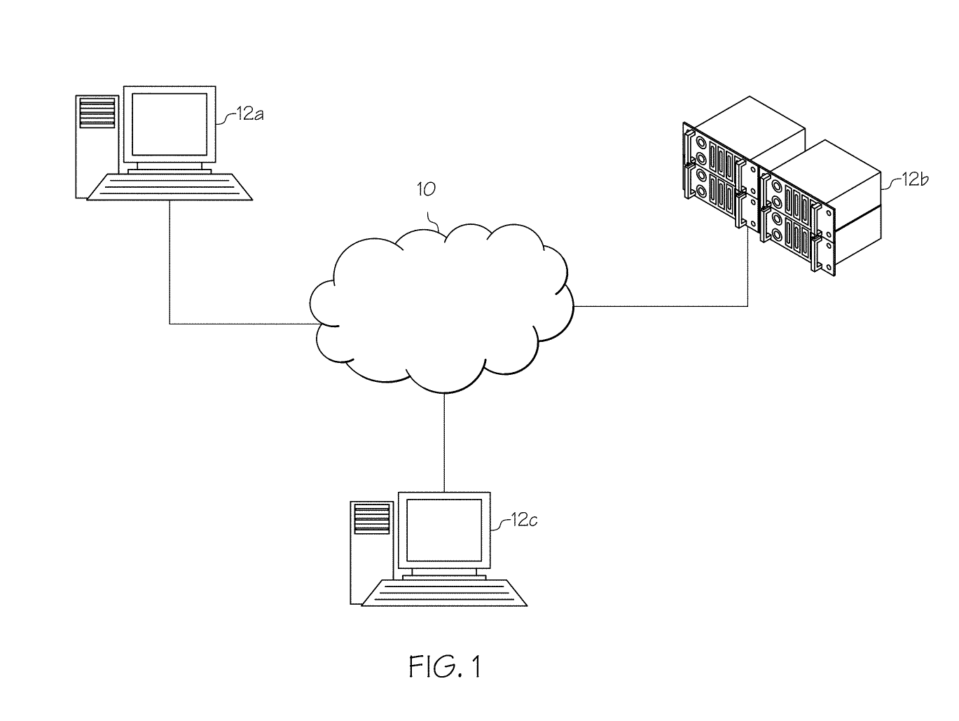

Referring now to the drawings, FIG. 1 depicts an illustrative computing network that depicts components for a system for detecting disease causal variants according to embodiments shown and described herein. As illustrated in FIG. 1, a computer network 10 may include a wide area network (WAN), such as the Internet, a local area network (LAN), a mobile communications network, a public service telephone network (PSTN), a personal area network (PAN), a metropolitan area network (MAN), a virtual private network (VPN), and/or another network. The computer network 10 may generally be configured to electronically connect one or more computing devices and/or components thereof. Illustrative computing devices may include, but are not limited to, a user computing device 12a, a server computing device 12b, and an administrator computing device 12c.

The user computing device 12a may generally be used as an interface between a user and the other components connected to the computer network 10. Thus, the user computing device 12a may be used to perform one or more user-facing functions, such as receiving one or more inputs from a user or providing information to the user. For example, the user computing device 12a may interface with a user to receive raw experimental data of epigenetic marks in a plurality of cell types from the user and/or may provide human interpretable and visualizable forms of the raw experimental data to the user. In addition, the user computing device 12a may provide other information to the user, such as information that is determined by the server computing device 12b and transmitted to the user computing device 12a. For example, the server computing device 12b may determine a target location for drug delivery and may transmit the target location to the user computing device 12a, which then depicts the target location in graphical format (e.g., by displaying a map or some other visual indication of the target location) such that a user viewing a display of the user computing device 12a can easily see where the target location is located and devise a drug delivery method that targets that location accordingly.

Accordingly, the user computing device 12a may include at least a display and/or input hardware. Additionally, included in FIG. 1 is the administrator computing device 12c. In the event that the server computing device 12b requires oversight, updating, or correction, the administrator computing device 12c may be configured to provide the desired oversight, updating, and/or correction. The administrator computing device 12c may also be used to input additional data into a corpus of data stored on the server computing device 12b.

The server computing device 12b may receive data from one or more sources, generate data, store data, index data, perform electronic data analysis, and/or provide data to the user computing device 12a.

It should be understood that while the user computing device 12a and the administrator computing device 12c are depicted as personal computers and the server computing device 12b is depicted as a server, these are nonlimiting examples. More specifically, in some embodiments, any type of computing device (e.g., mobile computing device, personal computer, server, etc.) may be used for any of these components. Additionally, while each of these computing devices is illustrated in FIG. 1 as a single piece of hardware, this is also merely an example. More specifically, each of the user computing device 12a, server computing device 12b, and administrator computing device 12c may represent a plurality of computers, servers, databases, components, and/or the like. In addition, each of the user computing device 12a, the server computing device 12b, and the administrator computing device 12c can be used to carry out any tasks or methods described herein.

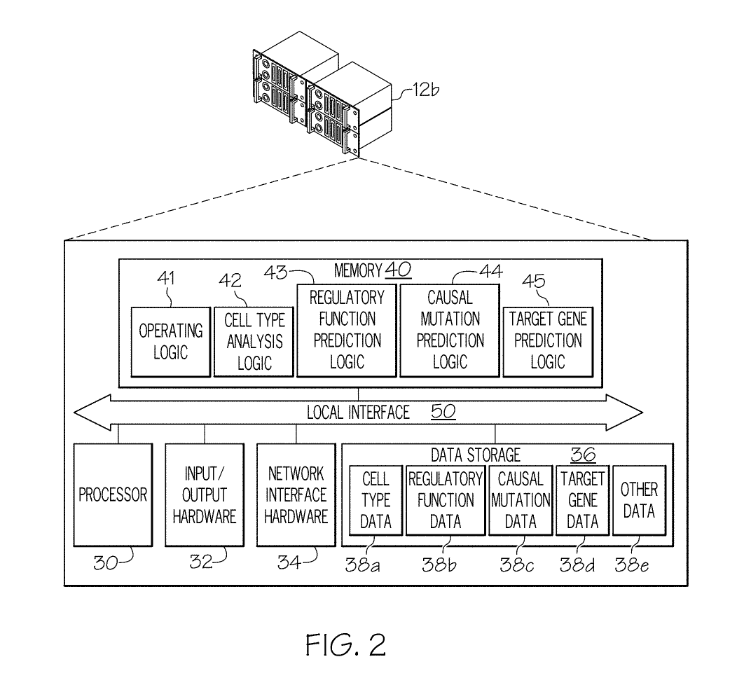

FIG. 2 depicts the server computing device 12b, from FIG. 1, further illustrating a system for predicting disease causal variants. While the components depicted in FIG. 2 are described with respect to the server computing device 12b, it should be understood that similar components may also be used for the user computing device 12a and/or the administrator computing device 12c (FIG. 1) without departing from the scope of the present disclosure.

The server computing device 12b may include a non-transitory computer-readable medium for searching and providing data embodied as hardware, software, and/or firmware, according to embodiments shown and described herein. While in some embodiments the server computing device 12b may be configured as a general purpose computer with the requisite hardware, software, and/or firmware, in other embodiments, the server computing device 12b may also be configured as a special purpose computer designed specifically for performing the functionality described herein. In embodiments where the server computing device 12b is a general purpose computer, the methods described herein generally provide a means of improving computer functionality (i.e., improving the ability of the computer to process data relating to detecting and predicting disease causal variants by arranging the data in a manner that is different from previous data arrangements). Specifically, an input matrix will have many thousands of columns in the predictor space, but only tens or hundreds of rows in the sample space. The methods described herein use a two-step procedure to reduce the dimensionality in the predictor space to hundreds, which will then be used to fit a full model. At the same time, the methods described herein expand the effective sample space to thousands or tens of thousands by including additional data, but only in the form of summary statistics (e.g., covariance matrices). As a result, the methods described herein are able to fit a complex model with limited samples more accurately and efficiently.

As also illustrated in FIG. 2, the server computing device 12b may include a processor 30, input/output hardware 32, network interface hardware 34, a data storage component 36 (which may store cell type data 38a, regulatory function data 38b, causal mutation data 38c, target gene data 38d, and other data 38e), and a non-transitory memory component 40. The memory component 40 may be configured as a volatile and/or a nonvolatile computer-readable medium and, as such, may include random access memory (including SRAM, DRAM, and/or other types of random access memory), flash memory, registers, compact discs (CD), digital versatile discs (DVD), and/or other types of storage components. Additionally, the memory component 40 may be configured to store various processing logic, such as, for example, operating logic 41, cell type analysis logic 42, regulatory function prediction logic 43, causal mutation prediction logic 44, and/or target gene prediction logic 45 (each of which may be embodied as a computer program, firmware, or hardware, as an example). A local interface 50 is also included in FIG. 2 and may be implemented as a bus or other interface to facilitate communication among the components of the server computing device 12b.

The processor 30 may include any processing component configured to receive and execute instructions (such as from the data storage component 36 and/or memory component 40). The input/output hardware 32 may include a monitor, keyboard, mouse, printer, camera, microphone, speaker, touch-screen, and/or other device for receiving, sending, and/or presenting data (e.g., a device that allows for direct or indirect user interaction with the server computing device 12b). The network interface hardware 34 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 36 may reside local to and/or remote from the server computing device 12b and may be configured to store one or more pieces of data and selectively provide access to the one or more pieces of data. As illustrated in FIG. 2, the data storage component 36 may store cell type data 38a, regulatory function data 38b, causal mutation data 38c, target gene data 38d, and/or other data 38e. The cell type data 38a may generally relate to information regarding cell types, including, but not limited to, identification information relating to a cell, information regarding genetic information within particular cell types, functional information relating to particular cell types, and/or the like. The regulatory function data 38b generally relates to information pertaining to the location in a DNA sequence at which molecular functions are turned on and off in specific cell types and thereby change gene expression level. The causal mutation data 38c generally relates to information pertaining to the locations in a DNA sequence at which a mutation may increase or decrease the risk for a carrier to develop the disease. The target gene data 38d may generally be data that identifies target genes that have an expression change that is a direct result of causal mutations and that disease risk is changed by the change of expression of genes.

Included in the memory component 40 are the operating logic 41, the cell type analysis logic 42, the regulator function prediction logic 43, the causal mutation prediction logic 44, and/or the target gene prediction logic 45. The operating logic 41 may include an operating system and/or other software for managing components of the server computing device 12b. The cell type analysis logic 42 may include instructions for analyzing and determining a cell type, as described in greater detail herein. The regulatory function prediction logic 43 may include instruction for predicting a regulatory function, as described in greater detail herein. The causal mutation prediction logic 44 may be used to determine and/or predict a causal mutation, as described in greater detail herein. The target gene prediction logic 45 may determine a particular gene that may be impacted by the predicted causal mutation, as described in greater detail herein.

It should be understood that the components illustrated in FIG. 2 are merely illustrative and are not intended to limit the scope of this disclosure. More specifically, while the components in FIG. 2 are illustrated as residing within the server computing device 12b, this is a nonlimiting example. In some embodiments, one or more of the components may reside external to the server computing device 12b. Similarly, as previously described herein, while FIG. 2 is directed to the server computing device 12b, other components such as the user computing device 12a and the administrator computing device 12c may include similar hardware, software, and/or firmware.

As mentioned above, the various components described with respect to FIG. 2 may be used to carry out one or more processes and/or provide functionality for predicting disease causal variants in a more efficient and effective manner without the need for greater processing power or excessive amounts of data storage. An illustrative example of such processes are described hereinbelow.

As shown in FIG. 4, joint models are developed to impute functions in new cell types, incorporate the predicted functions and gene expression data to identify causal variants, and further identify candidate target genes and driver cell types. Simultaneously, large-scale functional data sets are used to tackle small data problems for most diseases. Small data refer to the fact that only a few GWAS hits have been identified to date in most complex traits. To use methods described herein, the user only needs to provide a table of GWAS hits extracted from literature, and the sample size is internally expanded by using LD information. In addition, new solutions are proposed to predict target genes without using existing expression quantitative trait loci (eQTL) as training. This creates an alternative and complementary way to identify effector genes that do not depend on data availability, particularly in cell types without eQTLs.

At block 415, functions in new cell types with incomplete data may be predicted (e.g., regulatory functions across a whole genome in all cell types may be predicted) by first obtaining partial epigenetic data in new cell types at block 405 and obtaining a more complete list of existing epigenetic data in multiple cell types (of which the partial epigenetic data is a subset) at block 410, as described in greater detail below. This prediction means that the process will take both the partial data in new cell types and the complete epigenetic data in other cell types to calculate the probabilities of potential regulatory functions that may occur at every DNA position in the genome in the new cell types. The current IDEAS model requires all marks to be observed in all cell types, which is unrealistic due to cost, technical challenge, material availability. Even the ENCODE project and the Roadmap Epigenomics project (which are currently the two largest international projects generating gene regulatory data in human and mouse genomes) have 75% or more missing data tracks. There is a need of new methods to accommodate missing tracks when predicting functions. As such, it may be necessary to avoid directly imputing raw signals, as it imposes additional computational cost, and imputation errors will bias function predictions. This is completed by obtaining only partial epigenetic data in new cell types at block 405 and allowing IDEAS to predict regulatory functions directly from the partial data, along with other existing epigenetic data obtained at block 410 through a joint probabilistic model.

The IDEAS model is a hierarchical latent class model. The model connects to data only through its density function for each epigenetic state. The missing data problem is thus addressed in the density functions. For density functions in the exponential family, which most existing models for sequencing data analysis belongs to, analytical marginal forms on the observed marks can be obtained from the full density functions on both observed and unobserved marks. The full density functions may be replaced by their marginal forms. The parameters of the marginal density functions may be estimated from the incomplete data by an expectation-maximization (EM) algorithm. The EM algorithm works by integrating out the missing values in a Q-function that is an approximate of the log likelihood function, and then estimating the model parameters by maximizing the Q-function. The process is iterative that guarantees to converge to a locally optimal solution. For example, EM algorithm is typically used to solve mixture models, where a direct estimation of mixture models is difficult because its log likelihood function is a logarithm of summations. The Q-function for the mixture model, however, is a summation of logarithms, which is much simpler to optimize. EM for exponential family has elegant and fast analytical solutions. EM does not require signal imputation at the individual level, and thus it can be done very quickly. First, all missingness patterns may be identified in the input data matrix that only contains partial epigenetic data in some cell types. For each pattern, an EM algorithm may be used to calculate the expected values of the sufficient statistics associated with the full density functions. The estimated sufficient statistics may be summed over all missingness patterns and then the model parameters may be estimated by maximizing the total sufficient statistics. This procedure may guarantee a positive definite covariance matrix and is theoretically optimal if the data distribution is appropriate.

Given the predicted functions at each position in each cell type, the value of its missing signals can be further imputed from the probability density function. Each predicted function has an emission density function in the model, from which the missing signals can be directly simulated. The best guess of each missing signal can be predicted as the mean of the density function. This is equivalent to latent-class regression models, and it can capture non-linear relationships between the observed and unobserved signals.

Furthermore, the IDEAS integrative model may be used to predict functions in new cell types with incomplete data, as the marks may be treated as unavailable in the new cell types as missing data. In particular, results may be included from existing studies whose annotations are already done, and further include data from the new cell types of interest with just a few epigenetic marks available. The model need not be retrained on the existing results, nor does the raw data need to be accessed. All that is needed is the annotation and the model parameters output from the existing data, which will be used as priors in a Bayesian framework to predict functions in the new cell types. The basis of this approach is that existing annotation in multiple cell types is treated as epigenome templates, irrespective of whether the existing cell types are similar to the new cell types or not. The methods described herein may then construct a mosaic combination of the epigenome templates to best explain the observed data in new cell types. This is uniquely enabled by the 2D modeling of the IDEAS method, because the epigenome templates from existing results can be treated as “other cell types”, whose model is already trained, and the genomic position-specific distribution of functions in existing cell types are carried over by the model to the new cell types.

An illustrative example of the method is shown in FIG, 5, which combines ENCODE annotations in 6 major human cell types (generated by IDEAS) and ATAC-seq data in HL60 cell types at different time points to produce function predictions in the HL60 cell types. The results may be useful because it converts from originally 1-dimensional chromatin accessibility measure in HL60 to multi-category functions (such as promoters, enhancers, repressors) that are interpretable to human. These results are used to identify key regulators in HL60 that drives cell differentiation over time. Referring again to FIG. 4, the information may be transmitted to a researcher device at 420, as the information is useful for researchers to study gene regulation by providing them with the predicted regulatory functions in the cells. This also enables researchers to predict functions without generating many epigenetic data sets, which are costly and labor intensive.

At block 430, disease impactful functions and cell types from GWAS hits may be predicted (e.g., causal mutations, associated functions, and cell types may be predicted). Here, prediction refers to a calculation of probability vectors for the variants to be disease causal, and for the cell types to be the direct driver of GWAS signals. Existing methods fine-map causal variants but do not offer new insights on the cell types through which the mutations have impacts on disease risk. Methods are needed to identify functional elements and cell types through which disease mutations impact risks, and they should work on data with just a handful number of GWAS hits. As such, disease loci from GWAS hits may be obtained at block 425.

The premise of the approach described herein is that disease variants are highly enriched in regulatory elements in specific cell types, and variants affect disease risks at the regulatory level in a cell-type specific manner. For example, a large number of DNA mutations associated with bipolar disease are significantly more frequently overlapping with brain tissue specific enhancers than by chance, and these DNA mutations are likely to disrupt the functions of brain-specific enhancers and change gene expression in brain functions, thereby increasing the risks of bipolar disease. Thus, information can be leveraged from the predicted functional elements across cell types at all disease loci to identify cell type-specific patterns to best explain GWAS hits.

The genetic data that may be needed is a list of lead variants (variant with the strongest association in a locus), their p-values and sample ancestry, which can be obtained from either GWAScatalog or literatures. Since the lead variants may not be causal, the PICS (probabilistic identification of SNPs) method may be used to identify all candidate variants in LD with the lead variants and obtain their probabilities of being causal. This step expands the sample size as will be needed for model training, although the method does not rely heavily on this, as explained later. The PICS method works by assuming causality of each variant in a locus and use the signal at the variant to explain the association landscape at all other variants in LD with it. Both the lead variant and variants in LD with it may be referred to as PICS, and PICS may be considered with non-zero probability of being causal. The PICS method may generally be used because it only requires the lead variant in each locus, its p-value and sample ancestry. A script may automatically extract PICS results from the server in one or more batches.

In addition to PICS from GWAS, a similar number of control variants may be necessary, which will be random selected in the genome with matched allele frequency, spatial distribution, gene annotation and GC contents. PICS from GWAS with zero probabilities (but in LD) may also be added as control to adjust for locus-specific bias. Collectively, GWAS, PICS, and control variants may be referred to herein as “PICS”.

The predictor variable in the present model may be epigenetic states generated by the IDEAS method as described in Zhang et al., “Jointly characterizing epigenetic dynamics across multiple human cell types,” Nucleic Acids Research, 2016 and incorporated by reference herein in its entirety. The IDEAS method performs de novo identification of functional elements, represented by epigenetic states, in multiple cell types jointly. The present systems and methods improve the computational efficiency and reproducibility of the IDEAS method, such that it can produce highly accurate predictions in a single computer in all human cell types simultaneously. IDEAS may be used to produce a 20-state model, including billions of predictions, using 5 histone marks in 111 Roadmap Epigenomics cell types and 16 ENCODE cell types. Using five categories of experimental data sets (expression, enhancers, eQTLs, functional scores of DNA sequences, and chromatin interaction), the IDEAS predictions may be uniformly better than those published by the Roadmap Epigenomics project. Thus, the IDEAS predicted epigenetic states may be used in 127 cell types that overlap with the PICS obtained in step 1 as predictors in the model described herein. Epigenetic states may be used rather than raw histone marks as predictors, as the states are biologically easier to interpret, although the latter will also work.

Let X={Xᵢⱼ} be an indicator variable denoting the epigenetic states output by IDEAS that overlap with the ith PICS in the jth cell type. Note that each Xᵢⱼ=(Xᵢⱼ₁, . . . , Xᵢⱼₖ−1) is a (K−1)-dimensional vector of 0s and 1s for K distinct epigenetic states, with only one element being 1 and all other elements being 0. Given N cell types, the predictor vector Xᵢ. for the ith PICS is N(K−1)-dimensional, which is a few thousands for the Roadmap data mentioned above (N=127, K=20). Let Y={ Yᵢ} be the probability of being causal for the ith PICS. It is necessary to build a model connecting X and Y in the form of logit(Y)=α+h(X)+ε. The left hand side is a canonical link function commonly used for probabilities of binary outcomes (causal vs non-causal). To specify the function h(.) of epigenetic states on the right hand side, two common solutions exist: 1) use a linear model, i.e., h(Xᵢ)=ΣⱼₖβⱼₖXᵢⱼₖ; or 2) use a neural network to learn the h(.) function nonparametrically from the data. Either solution will involve fitting thousands or more parameters and thus may not work well in small samples.

The present solution to reduce model complexity is to assume a simple but interpretable form of the h(.) function. Let f={fₖ} denote the effect of the kth epigenetic state relative to a reference state (e.g., the Kth state), for k=1, . . . , K−1. f represents the innate effects of epigenetic states on disease risk, which are agnostic of cell types. Further, let c={cⱼ} denote the effect of the jth cell type agnostic of epigenetic states, with some constraints to ensure identifiability (e.g., mean 0 and norm 1). The h(.) function is then specified as h(Xᵢ.)=Σⱼₖ(f⊗ c) * Xᵢⱼₖ, where ⊗ denotes outer product of two vectors. That is, the epigenetic state Xᵢⱼ in the jth cell type at the ith PICS has effect equal to (Σₖf_{Xijk}) * cⱼ. This simple restriction of the model reduces the originally N(K−1) parameters in a linear model (e.g., βⱼₖ) to N+(K−1) parameters (e.g., βⱼₖ=fₖ* cⱼ), and simultaneously offers interpretability of the coefficients. The working assumption is that each epigenetic state has an innate effect (fₖ) that is further modulated within each cell type by a scalar cⱼ, which could be positive (e.g., increase risk), zero (no effect) or negative (e.g. decrease risk). It may be preferable to retain the linear form of h(.) for simplicity, but h(.) can be generalized to non-linear forms by inputting the innate effects (f ⊗1) * Xᵢⱼₖ into a neural network. This latter option may be beneficial for traits with enough number of significant and independent GWAS hits, such as height, body mass index, and obesity. By using a neural network, f may be interpreted as innate effects of epigenetic states, and the importance of each cell type may be assessed by sensitivity analysis.

An iterative update of f and c parameters may be performed from the data by conditioning on one another. This may be simple for linear models, but may be tricky for fitting a neural network. Fortunately, the number of parameters in f is small (e.g., K−1=19). A gradient descent method can be implemented where the derivatives with respect to f in the neural network can be estimated by adding small values to f, refitting the neural network and calculating likelihood ratio. Biologically it is sensible to further assume sparsity in the cell type modulating effect c, i.e., most cell types are likely irrelevant to the disease etiology and correspondingly cⱼ=0. The sparsity assumption will further help in model fitting for traits with fewer GWAS hits. For both linear model and neural network, elastic net penalty may be used to shrink parameter c, which consists of a L₁ penalty to achieve sparsity and a L₂ penalty to ameliorate multi-colinearity among predictors. The entire regularization paths may be calculated for linear models and cross-validation may be used to determine penalty parameters for neural networks by maximizing prediction accuracy.

As an output, the posterior probability of each PICS being causal may be calculated, where the prior is the original probability of causal given by the PICS method. This allows for fine-mapping functional causal variants to disease. In addition estimated effects of epigenetic states and cell types (f and c) may be obtained using the outer product of which can quantitatively measure how much each epigenetic state in a specific cell type contributes to disease risk. The epigenetic states that a PICS overlaps with, the estimated effects f and c, may together reveal PICS-specific, function-specific and cell type-specific effects on disease risks. Such information may then be used to extract groups of PICS that are driving disease association via unique combinations of functions and cell types. The PICS within each group may be more likely to share biological pathways, which may be tested using genome enrichment and gene ontology enrichment analysis. The output may be transmitted to disease genetics devices and/or drug target detection devices at block 440. That is, the output may be used by researchers using computing devices to detect particular disease genetics and drug targets. In some embodiments, the output may be used in devices that are particularly used for detecting and/or testing for disease genetics and/or devices that detect drug targets. For example, a blood-testing device may be designed to test a specific and small set of DNA mutations or target genes based on the predictions for the disease, which may substantially reduce false positives and the amount of blood sample needed. A device may be designed to sample from specific tissue types as predicted by the method, which may greatly increase the sensitivity of the test.

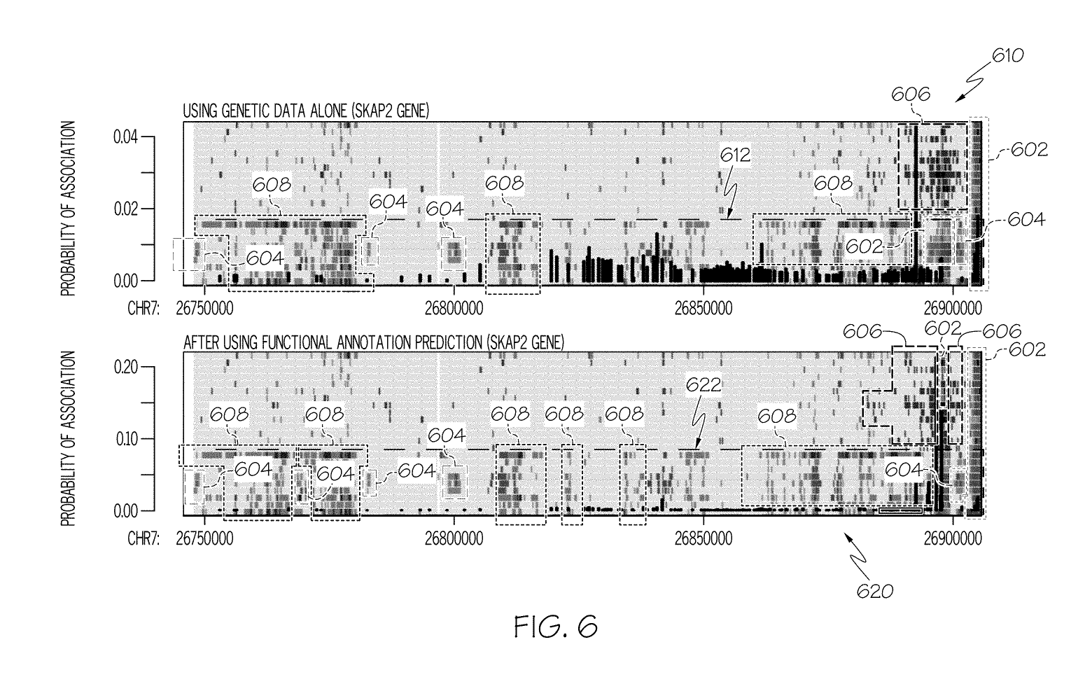

FIG. 6 depicts an example of the result after using function annotation to predict disease causal mutation. The disease is inflammatory bowel disease (IBD), which is an autoimmune disease and is known to be highly relevant to blood cell types. More specifically, FIG. 6 depicts a probability of IBD causal mutation predicted at the SKAP2 locus. The black vertical lines show the probability of being causal. The areas within a first boundary 602 indicate promoter activity, the areas within a second boundary 604 indicate enhancer, the areas within a third boundary 606 indicate repressor, and areas within a fourth boundary 608 indicate transcription. The upper panel 610 indicates results using genetic data alone, whereas the results using the present mention by combining function annotations, where are overlapped in the background, are shown at the bottom panel 620, which is better than using genetic data alone (upper panel 610), because the causal mutations are now overlapping with active enhancers in blood T-cells (boxed areas 612, 622). Note how the same locus is repressed in the blood B-cells, which indicates that the mutations may impact IBD by either turning off enhancers in T-cell, or turning on enhancers in B-cell. To further understand in which cell types the mutation may be more likely to be impactful on IBD risk, the proposed model may be used to predict cell types. The bottom panel 620 may be presented to a user via a user interface (e.g., on the user computing device 12a of FIG. 1), which allows a user to view raw experimental data in a visualizable format.

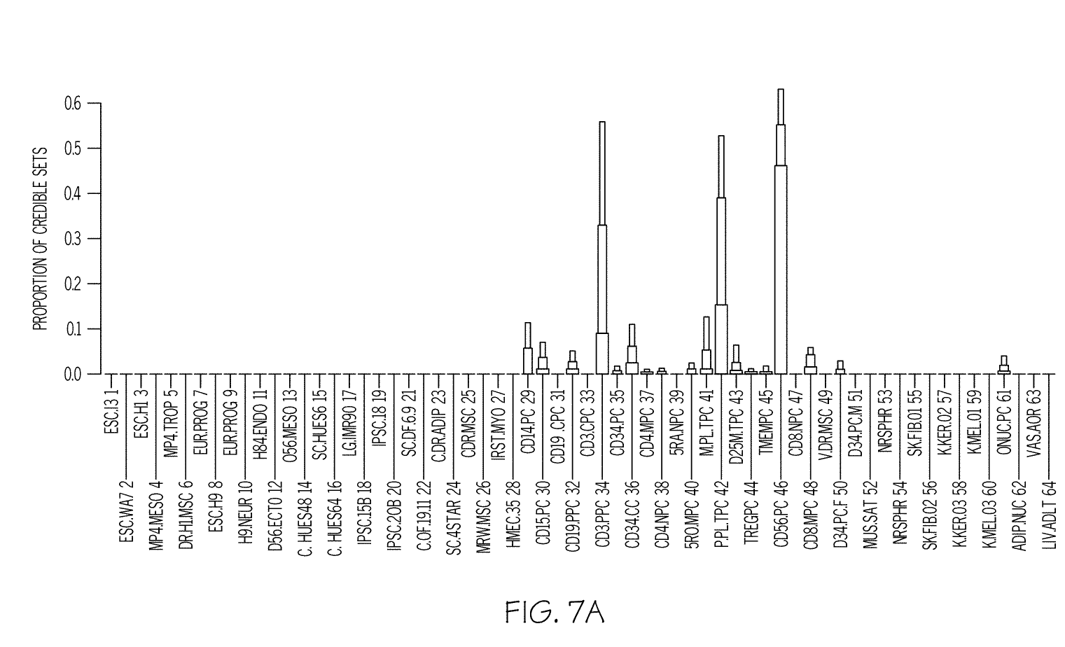

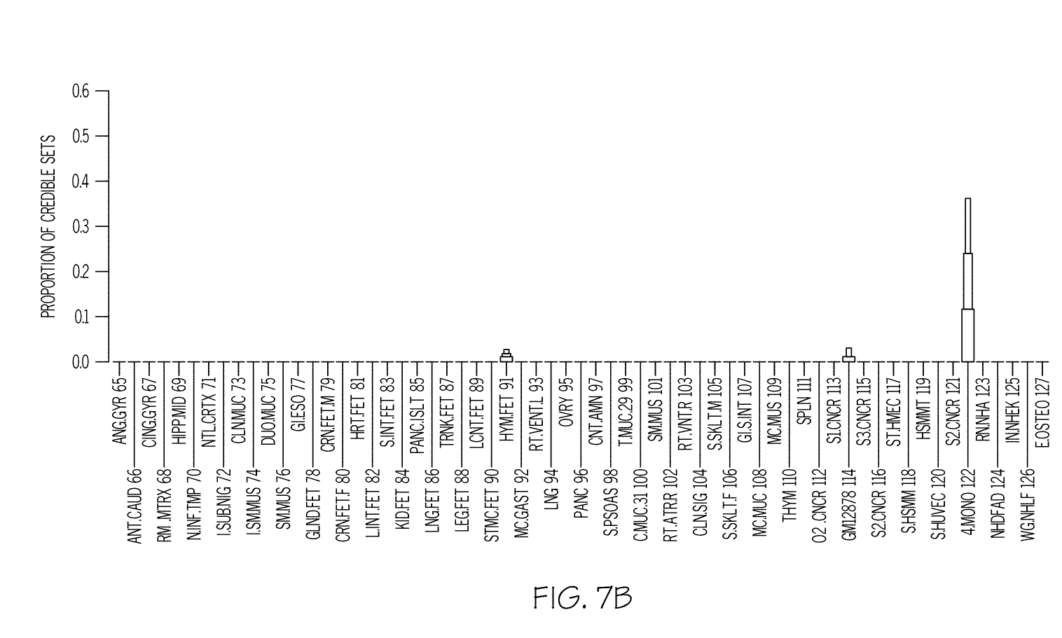

As shown in FIGS. 7A-7B, a specific T-cell (out of 23 blood cell types) has been identified that is most likely to drive IBD risks. The height of each bar in FIGS. 7A-7B shows the probability of each cell type being the driver of IBD risks. The different widths of each bar represent different levels of being driver. The widest bar shows the probability for each cell type being the most likely driver, the modest bar shows the probability for each cell type being the top 2 candidate drivers, and the thinnest bar shows the probability for each cell type being the top 3 candidate drivers.

Referring again to FIG. 4, at block 445, target genes of disease mutation may be predicted. That is, the probability for each gene within a neighborhood of disease mutations is calculated for how likely their expressions will change as a direct consequence of the mutations. Non-coding causal variants are believed to affect phenotype by disrupting gene expression. Current approaches to identify target genes of non-coding variants are to co-localize with eQTLs and/or use chromatin interaction data. While the eQTL approach is attractive by detecting molecular effects of disease mutations, it requires prior knowledge of disease-cell type relationships and data availability. The approach of using chromatin interaction data is limited by its low mapping resolution, and it does not provide information of molecular effects. New methods are needed to predict effector genes underlying disease susceptibility. Complementary to the eQTL approach, the present methods have much less contingency on data availability, so that it can be broadly applied to many traits and diseases. This will enable large-scale comparison of effector genes for shared/unique biological pathways across traits. It further enables the use of eQTL data and chromatin interaction data as independent validation.

The model referred to herein may be expanded by integrating additional information from RNA-seq data in Roadmap Epigenomics and ENCODE. That is, at block 435, RNA-seq data in a plurality of cell types may be obtained at block 435. Suppose that a DNA mutation affects disease risk by disrupting the functional elements it overlaps with and in turn changing gene expression in some cell types. The present model assumes that there are patterns in the functional effects on expression that can distinguish disease loci from control variants, and such patterns can be used to predict target genes. The premise is that regulatory elements are enriched in GWAS hits, and they have been successfully used to identify enhancer-promoter interactions, but their connections in disease have not been investigated.

RNA-seq data may be used and IDEAS predicted epigenetic states in 56 Roadmap cell types to calculate correlation between epigenetic states at each PICS location and expression of each gene within 1 Mb of the PICS. Alternatively, conserved large topological associated domains (TAD) may be used to identify genes for the PICS. To be inclusive, significant correlation may be identified at a liberal false discovery rate (FDR) of 0.1, which provides a list of PICS-gene pairs. For each PICS-gene pair, a gene-specific effect of epigenetic state on expression may be estimated and the effects may be standardized by expression standard deviation. Note that these effects are agnostic to cell types, but are specific to the PICS-gene pair. For example, if an enhancer has zero effect on the expression of one gene, it suggests that the gene may not be a target for the PICS.

Let X and Y denote the matrices of epigenetic states and PICS probability as defined herein. Let Z={Zᵢⱼₗ} denote the estimated effect of the epigenetic state at the ith PICS in the jth cell type on expression of the lth gene. Rows in Z correspond to PICS-gene pairs, and columns in Z correspond to epigenetic states in all cell types. To match Z with X and Y, the rows in X and Y are further duplicated by the number of candidate target genes for each PICS. Note that Z carries more information than X because values in Z are PICS-gene specific, while X and Y are PICS specific. The model of the present disclosure is then expressed as logit(Y)=α+h(X, Z)+ε. Specifically, either a linear form of h(X_{i·l}, Z_{i·l})=Σⱼₖ [(f₁⊗c₁) * Xᵢⱼₖₗ+(f₂ ⊗c₂) * Zᵢⱼₖₗ], or a neural network model is used to train h(.) using (f₁⊗1) * Xᵢⱼₖₗ and (f₂⊗1) * Zᵢⱼₖₗ as input. This is similar to the function described hereinabove, except that Z that carries information of functional effects on expression is now included.

A similar model fitting procedures as described herein may be used to estimate f₁, c₁, f₂, c₂. Sparsity in cell type effects c₁ and c₂ is assumed. However, both |c₁|+|c₂| and |c₁−c₂| are penalized. The former shrinks both effects in the same cell types to 0. The latter encourages similar effects in the same cell types. The number of parameters in the linear model is 2N(K−1)+1. To further reduce model complexity, a special case of c₁=c₂ is evaluated, which only requires fitting N(K−1)+K parameters, which is only K−1 more parameters than without using Z.

In other embodiments, instead of fitting a global model to all genes, when there are enough number of cell types with expression data available (i.e., greater than 30 cell types), a model can be fitted for each gene, or subsets of genes, separately. Using the state effects described hereinabove as predictors, an assumption is made that those effects are either 0 (such that the corresponding position does not regulate the gene) or non-zero with a positive mean and random effects (such that the corresponding position does regulate the gene). The mean could be 1, where more regulators for a gene indicate stronger expression, or be 1/k for k regulators such that only the types, but not the numbers of regulators, for a gene affect the magnitude of expression. The random effects are added to the mean to adjust for any additional effects of each regulator on the gene. To fit this model, mixed effect models combined with variable selection are used, where the latter is achieved by any of the following means: forward selection, backward selection, stochastic variable selection via MCMC, and penalty based variable selection techniques.

In yet other embodiments, when the expression data is not available in many cell types, it may still be necessary to fit a global model. However, additional information can be taken into the model to facilitate the selection of regulators for each gene. For example, chromatin interaction data has been shown to capture important gene regulatory events between regulators (either cis- or trans-) and genes. Alternatively, expression quantitative trait loci are valuable tools to identify regulator-gene pairs. Denoting these additional information as Wᵢ=(wᵢ₁, . . . , wᵢₖ) for gene i, where wᵢⱼ denotes either the observed data or processed signals for the additional information at k candidate regulators for the gene, the relationship between the expression of gene i and the k regulators can be expressed as E(Yᵢ)=α+βΣⱼwᵢⱼxⱼ, where coefficients α and β are global parameters to be estimated, and xⱼ are epigenetic states at position j. This model does not directly identify target genes of disease variants, as its response is expression. However, once the regulator-gene pairs are identified, the target gene of a disease variant can be identified as well.

As an output, the posterior probability of each PICS-gene pair being causal may be calculated, where the product of the original PICS probability and a uniform distribution on all candidate genes for each PICS is used as prior. PICS-gene pairs with large posterior probability then reveal causal variants and target genes. The estimated effects f₁, c₁, f₂, c₂ may then be used to identify cell types through which each PICS-gene pair has the most impact to disease risk. Finally, a mediation regression method may be used to evaluate the proportion of disease susceptibility (Y) explained by DNA mutations through either functional element (X) alone or through expression (Z). As described above, the output may be transmitted to a disease genetics device and/or a drug target detection device at block 440.

Accordingly, it should now be understood that the systems and methods described herein can be used to better identify disease causal mutations in a manner that does not require increased processing capabilities or excessive amounts of data storage. In addition, the molecular effects of the disease causal mutations can be better understood in a cell-type dependent context.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for detecting disease causal variants, the method comprising:
predicting regulatory functions across a genome in a plurality of cell types, wherein the plurality of cell types comprise incomplete data;
obtaining data comprising disease loci from one or more genome-wide association studies (GWAS) hits;
predicting one or more disease impactful functions on the plurality of cell types based on the data comprising disease loci; and
predicting one or more target genes of disease mutation in the plurality of cell types from the one or more disease impactful functions.

2. The method of claim 1, wherein predicting regulatory functions across the genome in the plurality of cell types comprises:
identifying all missingness patterns in a data matrix;
for each missingness pattern, using an expectation-maximization algorithm to calculate expected values of sufficient statistics associated with full density functions;
summing the sufficient statistics over all missingness patterns to obtain total sufficient statistics; and
maximizing the total sufficient statistics.

3. The method of claim 2, further comprising imputing a value of missing signals from one or more full density functions.

4. The method of claim 1, wherein predicting regulatory functions across the genome in the plurality of cell types comprises utilizing an Integrative and Discriminative Epigenome Annotation System (IDEAS) integrative model.

5. The method of claim 1, wherein predicting disease impactful functions on the plurality of cell types comprises determining an epigenetic state relative to a reference state using the function h(X_{i·})=Σⱼₖ (f⊗c)*Xᵢⱼₖ, where ⊗ denotes outer product of two vectors, f={fₖ} is an effect of a kth epigenetic state relative to the reference state for k=1, . . . , K−1, f is an innate effect of epigenetic states on disease risk, and c={cⱼ} denotes an effect of a jth cell type agnostic of epigenetic states.

6. The method of claim 1, wherein predicting the one or more target genes of disease mutation comprises utilizing RNA-seq data.

7. The method of claim 1, further comprising determining a target location for drug delivery based on the predicted one or more target genes of disease mutation.

8. The method of claim 1, further comprising determining disease genetics based on the predicted one or more target genes of disease mutation.

9. A system for detecting disease causal variants, the system comprising:
a processing device; and
a non-transitory, processor-readable storage medium comprising one or more programming instructions stored thereon that, when executed, cause the processing device to:
predict regulatory functions across a genome in a plurality of cell types, wherein the plurality of cell types comprise incomplete data;
obtain data comprising disease loci from one or more genome-wide association studies (GWAS) hits;
predict one or more disease impactful functions on the plurality of cell types based on the data comprising disease loci; and
predict one or more target genes of disease mutation in the plurality of cell types from the one or more disease impactful functions.

10. The system of claim 9, wherein the one or more programming instructions that, when executed, cause the processing device to predict regulatory functions across a genome in a plurality of cell types further comprises one or more programming instructions that cause the processing device to:
identify all missingness patterns in a data matrix;
for each missingness pattern, use an expectation-maximization algorithm to calculate expected values of sufficient statistics associated with full density functions;
sum the sufficient statistics over all missingness patterns to obtain total sufficient statistics; and
maximize the total sufficient statistics.

11. The system of claim 10, further comprising one or more programming instructions that, when executed, cause the processing device to impute a value of missing signals from the one or more full density functions.

12. The system of claim 9, wherein the one or more programming instructions that, when executed, cause the processing device to predict functions in new cell types comprises one or more programming instructions that, when executed, causes the processing device to utilize an Integrative and Discriminative Epigenome Annotation System (IDEAS) integrative model.

13. The system of claim 9, wherein the one or more programming instructions that, when executed, cause the processing device to predict disease impactful functions on the plurality of cell types comprises one or more programming instructions that, when executed, cause the processing device to determine an epigenetic state relative to a reference state using the function h(X_{i·})=Σⱼₖ (f⊗c) * Xᵢⱼₖ, where ⊗ denotes outer product of two vectors, f={fₖ} is an effect of a kth epigenetic state relative to the reference state for k=1, . . . , K−1, f is an innate effect of epigenetic states on disease risk, and c={cⱼ} denotes an effect of a jth cell type agnostic of epigenetic states.

14. The system of claim 9, wherein the one or more programming instructions that, when executed, cause the processing device to predict one or more target genes of disease mutation comprises one or more programming instructions that, when executed, cause the processing device to utilize RNA-seq data.

15. The system of claim 9, further comprising one or more programming instructions that, when executed, cause the processing device to determine a target location for drug delivery based on the predicted one or more target genes of disease mutation.

16. The system of claim 9, further comprising one or more programming instructions that, when executed, cause the processing device to determine disease genetics based on the predicted one or more target genes of disease mutation.

17. A non-transitory, processor-readable storage medium, the non-transitory, processor-readable storage medium comprising one or more programming instructions stored thereon that, are executable to:
predict regulatory functions across a genome in a plurality of cell types, wherein the plurality of cell types comprise incomplete data;
obtain data comprising disease loci from one or more genome-wide association studies (GWAS) hits;
predict one or more disease impactful functions on the plurality of cell types based on the data comprising disease loci; and
predict one or more target genes of disease mutation in the plurality of cell types from the one or more disease impactful functions.

18. The non-transitory, processor-readable storage medium of claim 17, wherein the one or more programming instructions that are executable to predict regulatory functions across a genome in a plurality of cell types are further executable to:
identify all missingness patterns in a data matrix;
for each missingness pattern, use an expectation-maximization algorithm to calculate the expected values of sufficient statistics associated with full density functions;
sum the sufficient statistics over all missingness patterns to obtain a total sufficient statistics; and
maximize the total sufficient statistics.

19. The non-transitory, processor-readable storage medium of claim 17, wherein the one or more programming instructions that are executable to predict disease impactful functions on the plurality of cell types are further executable to determine an epigenetic state relative to a reference state using the function h(X_{i·})=Σⱼₖ (f⊗c) * Xᵢⱼₖ, where ⊗ denotes outer product of two vectors, f={fₖ} is an effect of a kth epigenetic state relative to the reference state for k=1, . . . , K−1, f is an innate effect of epigenetic states on disease risk, and c={cⱼ} denotes an effect of a jth cell type agnostic of epigenetic states.

20. The non-transitory, processor-readable storage medium of claim 17, further comprising one or more programming instructions that are executable to determine disease genetics based on the predicted target genes.
